(19) United States
(12) Patent Application Publication
(10) Pub. No.: US 2007/0292004 A1
(43) Pub. Date: Dec. 20, 2007

(54) Position-Determining and -Measuring System

(76) Inventor: Heiko Peters, Bonn (DE)

Correspondence Address: K.F. ROSS P.C., 5683 RIVERDALE AVENUE, SUITE 203 BOX 900, BRONX, NY, 10471-0900, US

(21) Appl. No.: 11/659,603

(22) PCT Filed: Aug. 5, 2005
(86) PCT No.: PCT/EP05/08505

§ 371 Date: Feb. 6, 2007

(30) Foreign Application Priority Data
Aug. 6, 2004 (DE) 10 2004 038 545.9

(51) Int. Cl. G06T 7/20

(52) U.S. Cl. 382/120

(57) ABSTRACT

The invention relates to a method for determining the position of at least one object (13, 22, 23), which is characterized in that images of at least one object (13, 22, 23) are captured by means of a single electronic camera (21). At least one optical auxiliary structure (1) is arranged on the object (13, 22, 23) to be measured or on other constructions that have a permanent spatial relationship to the object (13, 22, 23) to be measured. The measures/positions of the at least one object (13, 22, 23) in relation to the at least one reference position or a reference position which is simultaneously captured by the camera (21) are determined by evaluating the positions of the at least one auxiliary structure (1) in the captured images by means of a computer program. The invention also relates to a software and to an auxiliary transfer device which at one end comprises a coupling element (5) which allows a distinctly repositionable assembly on a face bow (20) comprising optical auxiliary structures (1) or on a device for the assembly (17) of at least one jaw model in an articulator (4) on a corresponding counterpart. The invention also relates to a device for the assembly of at least one jaw model in an articulator and to auxiliary devices for carrying out said method.

The invention relates to a method for determining the position of at least one object and to a position-measuring system, software therefore, and equipment therefor. It is thus possible to determine the position of one or more objects in two- or three-dimensional space through optical capture by means of an electronic camera and evaluation of the images by appropriate image-recognition software using a computer.

Determining the position of static or moving objects in real-time or based on recorded images is thus possible.

### PRIOR ART

Until now, technically complex and cost-intensive methods were used for position determination and positioning in many areas of engineering and medicine.

Examples of previously used navigation and position-measuring systems in two- or three-dimensional space are satellite navigation, distance measurements by ultrasound emitters and receivers, distance measurement by light transmitters and receivers (infrared, laser, etc.), optical capture by stereooptical systems with two or more cameras, mechanical or electromechanical recording of movements, mechanical measuring of static positions by auxiliary mechanical devices and mechanical measuring devices.

In the present state of the art, navigation and position determination is used in areas such as position determination of vehicles and other objects on or below the earth's surface, vehicle parking assistance, drilling of holes in bones for the placement of tooth implants, endoprotheses (e.g. hip-joint replacements) controlled by a positioning system, instrumental functional analysis of the chewing system (recording and measuring the movements of the mandibular joint, joint-related position determination of the jaw, assembling jaw models for making dental prostheses in a chewing simulator, the so-called articulator, diagnosis of pathological changes of the stomatognathic system, craniomandibular dysfunctions (CMD).

For the latter use in oral medicine, there are essentially four [sic] methods that currently allow information about the condylar axis position and joint movements to be obtained, i.e. mechanical recording by placement of a facebow aided by anatomical reference points, mechanical recording by placement of a facebow aided by anatomical reference points, and recording of joint movements with pens on writing surfaces mounted on the face-bow near the joint. The pens are guided by a mechanism attached to the lower mandible. Also included is electromechanical recording by applying a facebow aided by anatomical reference points and recording the jaw movements through electromechanical transfer using a mechanism attached to the lower jaw and electronic recording through ultrasound sensors. The stationary receiving sensors are not attached randomly on the head or with a face-bow similar to the usual face-bows positioned with respect to anatomical features. The ultrasound transmitters that facilitate movement are fastened mechanically at the lower jaw (DE 10218435).

For assembling the jaw model in an articulator, the following methods are currently known, all known methods being based on a purely mechanical transfer of the measured jaw relation in the articulator: 1. Placement of the facebow at the corresponding reference points of the articulator, and attachment of the jaw model in the articulator using plaster by repositioning the model in the impressions of a deformable recording material, with which a bite fork is provided, or by repositioning the model in a an impression that matches the jaw template. This bite fork or pattern is mounted on the facebow, which is placed at the articulator, while the model is assembled in the articulator in exactly identical fashion as when recording the patient. 2. instead of the above-described facebow, an auxiliary device with the same measurements as the facebow is used for assembling the model. The bite fork or pattern used when recording the patient are mounted on this auxiliary device in order to assemble the model. The jaw model is fastened in this articulator using plaster. 3. Random assembly of the jaw model in the articulator without measuring. 4. Mounting the jaw models in specific articulators belonging to systems that are unable to determine or transfer condylar positions.

### Problem

Characteristic of all previously known navigation methods is that they either provide accurate measurement results, but are technically highly complex and expensive to do, or produce very inaccurate measurement results, but are inexpensive and technically simple.

For accurate three-dimensional position determinations, the previously known optical measurement systems need at least two cameras. The three-dimensional data are computed based on overlapping the image information. Exact positioning of the cameras is critical for obtaining precise measurements. Systems with several cameras require high computing power and a very accurate mechanical design.

Measuring systems with several sensors, receivers or cameras, are problematic in that when increasing the distance to the measuring points, the angle between the measuring points and sensors, receivers or cameras becomes more acute, thus diminishing measuring accuracy, and increasing effects such as movements of sensors, receivers or cameras relative to one another, e.g. due to vibrations, thus influencing measuring accuracy.

For this reason, all known techniques require very complex technical designs in order to obtain the necessary accuracy. With regular camera- and computer-mass-production technology, such designs cannot be realized. These techniques are therefore very expensive to acquire, which prohibits their expansion into many useful fields [of application].

Navigation systems, including three-dimensional measuring systems, are especially used in oral medicine. Measurements of the mandibular-joint position and mandibular-joint movements are important for instrumental functional analysis and recording used in prosthetic treatment or for functional diseases of the stomatognathic system.

Knowledge of the exact location of the condyles and the patient's joint movements is critical in order to produce a dental prosthesis in the laboratory aided by a chewing simulator with minimum corrections on the patient and for perfect functioning.

Known systems for determining condylar positions and joint movements (condylography) are extremely time-consuming to use in practice, and require well-trained users in order to obtain acceptable recordings. This the reason why dental treatment providers generally only determine arbitrarily the hinge axis position of the condyles with standard facebows or not at all, and quality lapses are tolerated in order to save time.

All known apparatuses and methods require that the patient perform exact movements categorized as the following movement sequence: Protrusion, opening, right laterotrusion and left laterotrusion.

The required equipment that needs to be mounted on the patient is highly stressful to the patient in all known processes and negatively affects movements.

In addition, all known apparatuses and methods cannot determine the exact position of the upper and lower jaw relative to one another in centric condylar position, or another therapeutically desirable position. In order to determine this relationship, mechanical recordings of very different types are done.

With all known apparatuses and methods, the measured jaw position relative to the mandibular joints and other anatomical reference points are transferred in a purely mechanical fashion to the dentistry lab for assembly of the jaw models in the articulator. This purely mechanical transfer causes certain problems.

With mechanical information transfer to the lab, external effects (shocks, temperature, vibrations, etc.) may cause changes in mechanical parts (facebow, gags, arrow-angle/support-pin registration, wax records, etc.) to appear, which in some cases may not be visible and represent sources of error when making the dental prosthesis.

An object of the invention is to provide a universal method for determining the position of objects, and a position-measurement system and positioning system having a high degree of accuracy, but managing with a low amount of technical complexity, and therefore inexpensive to produce, and available for many tasks, and does not have these disadvantages. Thus, this method and positioning system may be employed in many technical and medical cases where an accurate positioning system is not an option due to its high costs but still greatly useful for reasons of economy and quality.

The subject matter of the present embodiment of this invention is the dental application of a system for instrumental functional analysis, registration, model assembly in an articulator, condylar path measurement, and condylar axis position determination having substantial advantages over known systems. A further object is to provide a method for determining the position of vehicles relative to any reference points, e.g. in order to facilitate or automate navigation of such a vehicle, e.g. securely approaching a reference point.

### EMBODIMENT OF THE INVENTION

This problem is solved by the features of claims 1, 2, 24, 26, 29, 42 and 43. Advantageous further developments of the invention are mentioned in the dependent claims.

The reference system and/or reference position for determining the position of an object may be, e.g. the camera position, or one of the objects captured via the camera independently of any freely selectable camera position, or a certain reference position characterized by at least one auxiliary structure, similarly as an object to be captured, and recorded by a camera.

The results obtained from processing of the image may be used for exact position determination, or for positioning of another object, or one of the measured objects. When capturing movements, the exact movement sequences may be determined, especially with reference to the relevant captured coordinates, and in an exact chronological context, if required.

Position determination of the object to be measured is done by optical acquisition by an electronic camera and further processing of these data, particularly using the software according to the invention. The software according to the invention enables determination of the three-dimensional measurements of this object so as to describe the three-dimensional position of the object.

The system according to the invention needs only a single camera to work. In order to obtain a certain amount of redundancy, it may be beneficial in certain applications to operate with more than one camera.

Depending on the capacity of certain image-analysis software or the utilized computer, or the simplicity of the optical structures, the object to be measured may itself be captured, or at least one optical auxiliary structure, placed at the object to be measured, may preferably be used. Especially with bodies of a simple shape and known dimensions, such as rectangles, or when measuring accuracy requirements are low, the placement of optical auxiliary structures may be omitted. In all other cases, these optical auxiliary structures facilitate optical recognition with the computer program according to the invention. Alternatively, when arranging a camera on the object, the environment provided with at least one optical auxiliary structure may be recorded in order to determine the position of the object in the environment based on these images.

Such auxiliary structures may be colored surfaces, bodies, reflective surfaces or reflective bodies with known dimensions. Especially with three-dimensional measurements, spheres are useful in order to avoid projection errors. The camera, independently of its orientation, always captures an undistorted circular image of spheres. This minimizes errors of measurement, reduces the amount of computation, and accelerates computation. When acquiring an image of a circular area, an oval projection image or one that is too small may result depending on the viewing angle, and thus introduce possible errors of measurement. This is similarly true for all other surface and body shapes. However, these errors or measurements may be avoided by suitable computational steps, although this may reasonably involve the use of more than one optical auxiliary structure in some situations.

In contrast to all other bodies, spheres always form an identical image in a two-dimensional depiction regardless of the observational position, and only differ in size. This image is always a circle. All other bodies form a two-dimensional shape in a two-dimensional depiction that depends on the observed position. That is why spheres are especially suited as optical auxiliary structures.

Any number of auxiliary structures may be used. Whether and how many auxiliary structures are used depends on the intended use in question.

To accurately determine the three-dimensional position of an optically complex object, the placement of several, e.g. three is or four, auxiliary structures, preferably spheres, is recommended. These optical auxiliary structures form a group assigned to a certain point on an object. Thus, all optical auxiliary structures of a group need not necessarily be recognizable from a camera perspective, when performing position determination The same may apply to reference positions or other objects that are to be made optically capturable with optical auxiliary structures. The use of several auxiliary structures therefore allows for redundancy. When all or [only] portions of a structure should be covered [hidden], an excess amount of such optical auxiliary structures makes it possible to capture sufficient evaluatable data.

The auxiliary structures pertaining to an object to be measured are placed such that the exact position of the auxiliary structures relative to one another is known, preferably all the auxiliary structures are captured reliably by the camera, and the structures are distributed preferably evenly in two dimensions of space.

Since especially depth measurement by a monocular optical system involves the greatest computational effort, and is associated with the greatest potential for errors, it makes sense to align the auxiliary structures especially with the optical axis.

For instance, four auxiliary structures could be fixed trapezoidally on a surface approximately parallel with the optical axis, thereby spacing the two rear structures further apart than those in front. Three structures may be fixed on a triangle-shaped surface with obtuse angles.

The system will also work with only one single structure, however, significantly less information will then be available for exact computation.

The more auxiliary structures are present, the more information will be available for more exact computation, however, the computational effort will then also have to be increased substantially.

When image capture of an object or its environment is done without any auxiliary structures, the computational effort is likewise substantially greater than is the case, when auxiliary structures are used, but is still possible.

Selection of the color of the auxiliary structures follows the colors of the other objects captured by the camera. Image capture is done with optimal accuracy, when the color of the auxiliary structures differ as much as possible from the other predominant colors in the image. Non-shiny surfaces are preferred.

In order to obtain especially reliable image recognition, it is useful to provide the surroundings of the auxiliary structures with special contrast. With two-dimensional shapes, this may be done by using a sufficiently wide frame of a color that is in stark contrast to the surface color. Spheres or other bodies used as auxiliary structures may be provided with a background that contrasts greatly with the color of the sphere or body. It is thereby important, when increasing the contrast for all possible camera positions relative to the auxiliary structure, that this background preferably not be fully or partially covering [hiding] the body.

Moreover, the obtainable measuring accuracy depends on is the quality of the optical system, image resolution and measuring accuracy of the utilized auxiliary structures or the objects to be measured, if no auxiliary structure is being used.

The objects, whether provided with optical auxiliary structures or not, to be measured or their environment are captured by a camera. Preferably, the camera is carried on a stand. The images captured by the camera are either immediately evaluated, e.g. by a computing program according to the invention, or stored initially in the form of individual images or video recordings.

The computer program according to the invention first recognizes the shape or structures of the object, whose position is to be determined, or the contours or structures of at least one optical auxiliary structure positioned at this object, or, if the camera is fixed on the object, of at least one auxiliary structure in the environment. Thus, following recognition of the contours or structures, the two-dimensional image coordinates may be determined.

The greatest problems experienced by the known systems are mainly related to exact depth determination, when three-dimensional position measurements are done. Nevertheless, the method according to the invention manages with only one camera, and/or position determination is done based on only one or more images of a camera, or chronologically sequentially using different cameras.

Especially depth measurement, i.e. measuring in the z-dimension, is greatly dependent on the resolution of the utilized camera. Objects that are closer to the camera, are shown larger in the image, while objects farther away are shown smaller. This makes it possible to infer the (depth) distance of known auxiliary structures by comparing the relationship between their sizes. The smallest representable unit of measurement corresponds to one image element of the image recording camera sensor, i.e. one pixel. Depending on the camera resolution, the distance of the object and the optical properties, the depth resolution, i.e. resolution in the z dimension, is considerably greater than the height and width resolution, i.e. resolution in the x- and y-dimensions. Great resolution in the depth dimension is not suitable for many measuring tasks without using the software of the invention. High-resolution cameras make it possible to improve resolution. The computer program according to the invention, however, makes it possible with crude raw data to provide significantly improved resolutions in all three-dimensional directions. The algorithms of the computer program according to the invention utilize substantially more information contained in the images than merely the pixel dimensions of the image in order to obtain results that are as accurate as possible. Due to this computational method, the obtainable measuring accuracy is considerably greater than the image resolution obtainable with traditional methods.

Image recognition may be done for an object that is present in the camera's field of view or several objects that are simultaneously present in the camera's image field, or, if the camera is mounted on an object, for one or more auxiliary structures, and/or groups of auxiliary structures in the recorded environment of the object. Likewise, measurements of the positions of the objects relative to one another may be determined for further applications, as may the measurements of the positions of the objects present in the image field relative to the camera position as a reference value or relative to an arbitrary reference position.

The procedure of in principle determining the position of an object based on a two-dimensional camera image is described in more detail in dependent claims 8 through 10. Moreover, to assist recognition of auxiliary structures, a color analysis, e.g. a color histogram, of all pixels may be performed as a part of an image analysis in order to discriminate in a more simple fashion between auxiliary structures whose colors are prominent.

### First Embodiment

The invention may be used in dental medical applications, e.g. for instrumental functional analyses in order to determine data, allowing on the one hand adjustment of articulators in the dental medical laboratory corresponding to the patient, and on the other user decisions concerning a diagnosis and possible therapy. The assembly of dental (partial) prostheses may also be significantly simplified.

In this application of the invention, the data needed for determining condylar locations and movements are determined through optical acquisition. The data are analyzed by the program according to the invention and enable the transfer of the results in the form of data to a dentistry laboratory. The jaw models are mounted in the articulator by preferably using an apparatus according to the invention for assembling jaw models in an articulator (here referred to as a mounting table) that is set to the values determined by the program.

In this dental-medicine application, the patient's head and face structures or optical auxiliary structures fastened by facebows are captured optically by a single camera.

The images acquired by an electronic camera are analyzed by the computer program according to the invention.

The face itself, possibly with a mounted facebow with optical auxiliary structures, serves as a reference system. If during recording, the patient moves his head or the camera is moved, the relative positional relationship between the upper and lower jaws remains the same. Since the moving reference system also is captured optically, the lower-jaw position relative to the upper jaw position may be computed. It is therefore irrelevant whether during recording, the patient moves his head, or the camera is moved.

Instead of facebows, the use of optical indicia fixed immediately on the patient's skin is also possible. The motility of the skin relative to the osseous base cause inaccuracies that need to be taken into account during computation.

For other medical purposes, movements of other body parts may be measured with the aid of this invention.

According to the invention, the general procedure is that the patient moves his lower jaw in any way relative to the upper jaw. Images of these movements are then recorded by the camera. The images are analyzed—as described above—in order to determine the position of the lower jaw relative to the upper jaw is in each separate image. From the plurality of recorded images and individual positions obtained in this way, the points around which the lower jaw may move relative to the upper jaw, can be computed. The positions of the condyles may thus be determined.

Advantageous Effect:

In contrast to all other available positioning systems, the required technique is remarkably simple and also inexpensive to produce, since techniques that are essentially available from cost-efficient mass production may be employed. The invention uses essentially one or more electronic cameras, a computer, the method according to the invention, e.g. as software, and if needed or useful, optical auxiliary structures.

As a camera, all commercially available cameras may be used: internet cameras (webcams), digital photographic cameras or film cameras. Digital cameras may be employed, as may analog cameras with subsequent digitization of the image data.

Any commercially available computer with sufficient computing power may be used. Any state-of-the-art personal computer at the time of the invention is fully sufficient. The auxiliary structures are exceedingly simple to produce, as they consist merely of colored spheres, circular surfaces, or other simple bodies, preferably spheres, that are three-dimensionally fastened in a fixed and known position relative to one another at the object to be measured.

Since the optical auxiliary structures according to the invention do not have any active technology, such as electronics, and also do not require a power supply or cable connections, the effect of the mounted auxiliary structures on the measuring result is modest. These structures can be made very light.

Due to its outstanding simplicity, the positioning technique according to the invention is now available for any application, in which due to cost considerations or technical complexity a position-measuring system could not previously be applied in spite of its advantage. Furthermore, its accuracy is better, notwithstanding its low technical complexity.

Especially for dental medical applications in the field of prosthetics and functional analyses, the following considerable advantages over known systems become apparent: It may be operated by more cost-efficient medical-practice personnel, it increases revenue of the dental practice, it improves quality, and it reduces costs of the produced dental prosthesis with fewer corrections and less time consumption.

In the virtual computation of the centric mandibular joint position and the associated omission of a centered registration or a support-pin/arrow-angle registration lies a considerable advantage of this embodiment according to the invention, i.e. these procedures may be omitted.

Only data and the related transfer auxiliary device need now be submitted to the dentistry laboratory. These transfer auxiliary device are mechanically very simple and inexpensive. Besides the transfer auxiliary devices that can be produced individually for the specific patient case, the ready-to-use transfer auxiliary devices can be stored inexpensively in large numbers. In every day practice, this means that a registration always can be done, when needed, without prior planning and organization. Until now, expensive mechanical parts had to be exchanged between laboratory and practice (facebows, transfer gags, arrow-angle/support-pin systems, etc.).

Registration with this system according to the invention is substantially better documented than was previously possible. Movements may be checked later at any time, since they exist as video recordings. With later software improvements, existing video recordings may again serve as a computational basis. Extensive documentation allows for improved evaluation of successful treatments. Highly exact statements about the jaw-joint anatomy can be made without invasive steps, X-ray photography and tomograms.

This embodiment of the invention simplifies the instrumental functional analysis considerably due the following characteristics:

There is no absolute need for the patient to perform certain movements. Generally, it is sufficient that the patient do any movement. Exact movements are not required, however, they do increase accuracy.

Due to the simplicity of operation, the operator need not have special knowledge. For flawless operation, a simple set of directions is sufficient. The program according to the invention is automatically able to test the captured data in terms of quality. The operator during data capture need not be the same as is the user of the captured data, since anyone analyzing data may test whether it is originally defective. Data capture may therefore be delegated to training personnel.

Only objects that hardly disturb the patient and are very light are mounted on the patient, or none are mounted at all. Data capture is done optically at a spacing that is comfortable for the patient.

Data for mounting the model in the proper condylar axis position are not mechanically transferred to the laboratory as, previously, but only in data form. The only mechanical part needed for data transport is, for example, a bite fork with dental impressions, or another simple transfer device.

In a further embodiment of the invention, any mechanical registration may also be omitted. It may done by capturing/scanning the three-dimensional dental contours, or at least three distinctive points of the teeth directly in the mouth by use of the proper camera technique, the three-dimensional contour or distinct points captured in this way being placed in a mathematically representable three-dimensional relation based on a reference system, e.g. the reference indicia on the upper jaw/head, since, e.g. the position of the scanning camera is known. The data thus captured may then be used in order to assemble the jaw models in the articulator assisted by the apparatus according to the invention for model assembly, without requiring mechanical registration. An advantage of this embodiment of the invention is that there is no need anymore for mechanical recording devices to be transferred to the laboratory, instead all the required information now exists only in the form of digital data. This procedure requires that the jaw models of plaster or plastic, or the like, also be optically scanned in order to produce a proper relation between the image of the real teeth captured in the mouth and the model, or, alternatively, that at least three distinct points of the teeth and their corresponding sites on the models are indicated or optically captured.

Optical capture of the registrations as a negative form of the dental impressions or optical capture of at least three distinct points in the registration and, similarly as described above, computational establishment of a reference to the model to be assembled in the articulator, which model is mounted in the articulator for model assembly assisted by the apparatus according to the invention.

The invention makes it possible to measure the exact intercondylar spacing, the condylar axis, and the exact condylar location on the axis proceeding through both condyles.

Jaw-joint positions and jaw positions may be simulated by the software, centric registrations and support-pin and arrow-angle recordings and precise determinations of the vertical relation with wax dams or other, auxiliary devices being no longer needed. The system is capable of virtually determining condylar center positions. The production of a complete prosthesis, for example, is substantially simplified. It is precisely within implantation prosthetics that high functional accuracy of the shape of the dental prosthesis is critical. In the virtual computation of the is center of the mandibular joint and the omission of a centric registration or support pin/arrow-angle recording lies a considerable advantage of the embodiment according to the invention.

It is precisely in the virtual field that advantageous effects come about, when making a dental (partial) prosthesis, e.g. by using the CEREC technique.

With this technique, we know how to produce a dental prosthesis directly when treating a patient, or following the production of a model, by milling a solid block. However, the treating dentist or dental technician must then, essentially on his or her own, shape the masticating surface of the tooth to be prepared. Here, the invention gains considerably importance.

As mentioned above, the invention makes it possible to measure the exact position of a patient's jaw. Also, at least the tooth to be prepared and an opposing tooth (area) may be captured, as may all the teeth of a jaw in order to obtain (e.g. three-dimensional) image information about the teeth, if needed. According to the invention, a patient's jaw may therefore be simulated fully, or at least partially, in a computer system, information about the patient's specific masticating surfaces and their arrangement to one another, especially also when jaw movements occur, becoming available.

Based on existing jaw data, a comparison of a tooth to be prepared with an opposing tooth (area) may be simulated with maximum accuracy in order to determine how to form the masticating surface of the tooth to be prepared, so that it inserts itself into the existing masticating surface of the opposing tooth during chewing. It is therefore possible, when performing per se known in situ cutting of an inlay, also to produce optimally adjusted masticating surfaces on the tooth (partial) prosthesis. Thus, the usual rework following the creation of a CEREC filling may be omitted, or at least simplified considerably. This application according to the invention is not limited to the creation of dental prosthesis by using the known CEREC system, but is also ideal, when creating the dental prosthesis in a usual lab-supported way. At any rate, masticating surfaces shaped in a pathologically correct way may be made, since the system according to the invention is able to place a virtual model of a tooth or jaw segment or the whole jaw in relation to a virtual articulator in order for the determined condylar positions or kinematic centers of the condyles and the mandibular joint paths to be used.

The invention may be used in many technical and medical fields for navigation, position determination and positioning in two- or three-dimensional space, and for recording and analyzing movements, e.g. in all these prior-art fields. The preferred application is in the field of vehicles, e.g. towing vehicles for airplanes, when the nosewheel of an airplane must be grasped securely, or for vehicles, e.g. stripping excavators above or below ground.

### Second Embodiment of the Invention

With the method according to the invention, the position of vehicles relative to a reference point may also be determined. For this purpose, at least one optical auxiliary structure may be fixed on vehicles. One or several cameras may be fixed in the vicinity, capturing at least one vehicle, or the auxiliary structure(s). The position and especially also the alignment of at least one camera are known and represent the reference position.

Thus, when recording and analyzing images according to the method described above, the position of the vehicle may be determined.

Alternatively, a reference position may also be provided by another distinct point and not the camera. For example, in the space or environment of the vehicle, at least one further optical auxiliary structure may be fixed and represent the known reference position. The camera position then doe not need to be known.

Alternatively, at least one camera may be fixed on a vehicle and carried along with the vehicle. In the vicinity of the vehicle, optical auxiliary structures may be provided and the position relative to the auxiliary structure determined by using the camera as reference. A vehicle may then locate a certain path relative to the optical auxiliary structure and be guided on such a path, if needed.

Based on the position determination, an operator may automatically be instructed to control the vehicle, e.g. to approach a target, or the vehicle may be navigated automatically in order to reach that target. The target may thereby also be defined, e.g. by an optical auxiliary structure of the above-mentioned type, or e.g. by a projected image.

Applications below ground include the control of stripping excavators that need to approach an excavation heap as their target. At a tunnel or a gallery ceiling, e.g. optical auxiliary structures may be provided, as may at least one camera on the excavator, or vice-versa. Airplane tractors attaching to the nosewheel of an airplane may thus accurately approach the nosewheel. For this purpose, a nosewheel may have an optical auxiliary structure that may also be glued to the undercarriage, e.g. using circular surfaces, which is not a problem here, since normally a nosewheel is approached from a specific defined direction and spheres are therefore not necessarily needed. The nosewheel itself or the undercarriage construction may itself represent an optical auxiliary structure, so that additional ones need not be placed.

For all these options, the software may be located on a data medium in the vehicle or outside the vehicle. Data transfer may be done wirelessly, by infrared, optical fibers or cable. The vehicle is controlled by the software on a data medium in a computer.

In a further embodiment, the software may store the path that was traveled. This feature may e.g. be used by a person to steer the vehicle along a path to be automatically traveled later, while the software stores the path. The unmanned vehicle may then later retrace this path, controlled by the present navigation system according to the invention. An advantage over other solutions is that obstacles and path restrictions need not be elaborately scanned or otherwise sensed during travel.

With reference to the above-described embodiment, a camera and a projector may be placed above a heap of waste. The projector projects a pattern, e.g. stripes, onto the excavation heap. The camera captures the image projected onto the waste heap. Camera and projector are positioned such that the part to be processed of the waste heap is captured. The camera and projector may be placed at an optimal location by means of a positioning device, if required. Such a positioning device may consist, e.g. of an articulated arm or a rail system.

Due to the various distances to the waste material to the projector, the projected pattern appears distorted. The image captured by the camera is analyzed by software on a data medium. Based on the distortions, the distances to the surface regions of the heap may be computed.

The position information for the excavator and the information for modeling the heap, as determined by the software, may be used for placing the camera and the projector in an optimal position, if required.

The information about the three-dimensional shape of the heap may now be used for optimal control of the excavator's position in order to obtain maximum excavation efficiency. In a corresponding embodiment of the invention, the excavator, controlled by the software on a data medium, may automatically assume an optimal excavation position relative to the waste heap, and enter the waste heap with the excavator shovel and pick up an appropriate amount.

This technology functions in similar fashion with other excavation vehicles and methods (conveyor belts, rotating excavation shovels, etc.).

For all designs, only one camera is sufficient due to the special software in order to determine three-dimensional information, i.e. several cameras are no longer needed. If the whole observable area is not captured by the field of view of a camera, data capture may be ensured through positionable, rotatable, pivotable cameras, or by using more than just one camera. If for the sake of security data redundancy is desired, then several cameras may be useful, as well. For instance, when used very dirty areas, flawless image capture may not always be guaranteed in certain circumstances due to fouling of the camera optics. In such cases, redundant cameras would ensure continued operation.

The dimensions of the work range for the excavation equipment are either stored on an electronic card set in relation to the appropriate reference points formed by optical indicia or the camera positions, or the software contains space limitation information via electronic distance sensors that are placed on the excavation equipment, e.g. ultrasound emitters and receivers measuring the spacing to the opposing object by propagation time measurement of the ultrasound signals. Laser-scanner systems may, also be used as an alternative, the distance being determined by propagation time measurement of the light signals.

Complicated or indefinite shapes of bodies, whose positions are to be determined, require optical locating indicia. The optical indicia may either be self-powered and glow or are illuminated by an external light source. To enable perfect assignment of these indicia, they may be employed in different colors.

With simple or definite shapes of the bodies, whose positions are to be determined, additional indicia may be omitted. The profile contour of the body, whose position is to be determined, may in those situations be used itself as a shape to be recognized.

Further possible applications of the invention are guidance/navigation of fork lift trucks or other vehicles in storehouses, spacecraft, toys, e.g. remote-controlled model vehicles, measurement of the angle between airplane tractor and airplane, the software program itself capturing indicia placed on the airplane via a camera placed on the airplane tractor or the profile contour of the airplane body.

Based on the image evaluation performed by the software, the angle may be determined.

Below follows a description of an embodiment of the invention in the dental-medical field. The described embodiment is a part of the invention.

It concerns a system for optical recording of the lower jaw movements with evaluation of the data for adjustment of articulators and automated functional analysis.

The embodiment of the invention concerns instrumental functional analysis for the capture of data making possible, on the one hand, adjustment of articulators in the dentistry laboratory in a way that is suitable for the patient, and on the other, user decisions concerning a diagnosis and possible therapy.

The invention is explained in more detail below in reference to the drawings. Therein:

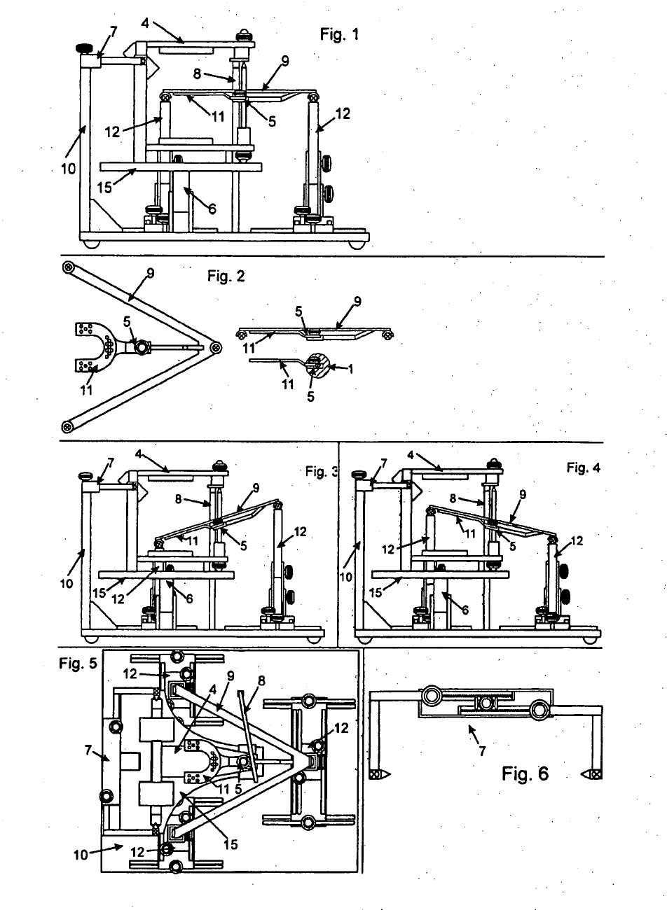

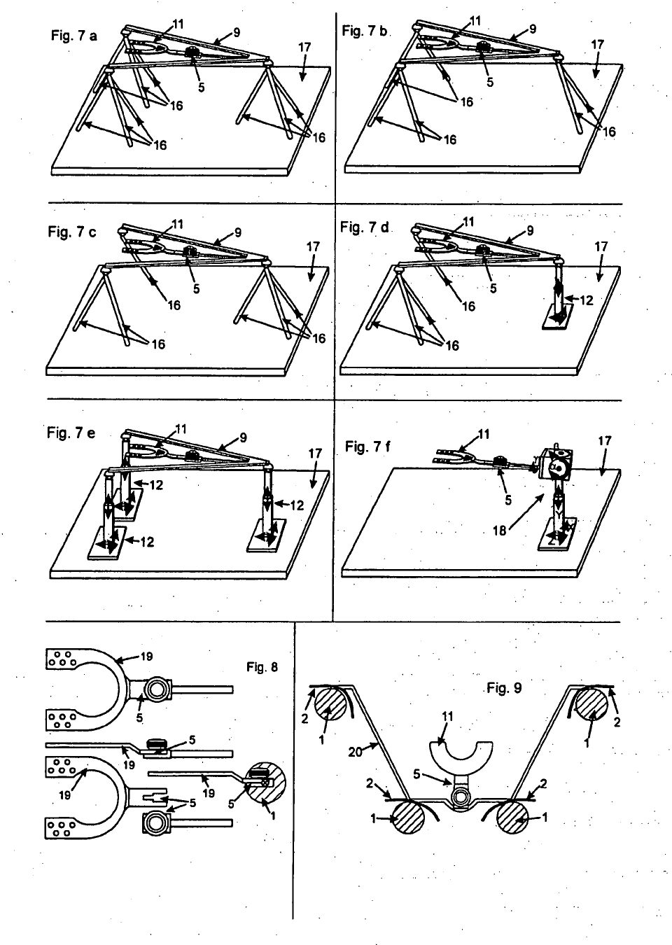

FIG. 1 is an advantageous embodiment of the apparatus according to the invention for assembly of the jaw models in the articulator (here referred to as an assembly table) in side view, set in the starting position, an articulator being drawn in schematically as an example, matching the image in FIG. 7e;

FIG. 2 is a detailed top view of an advantageous embodiment of the apparatus according to the invention for the assembly of jaw models in the articulator (here referred to as an assembly table), here an advantageous design of the surface resting on the adjustable supports, which surface contains a coupling element for fastening the transfer device (assembly triangle);

FIG. 3 is an advantageous embodiment of the apparatus according to the invention for the assembly of jaw models in the articulator (here referred to as an assembly table) in side view, adjustments being made such that the transfer device is tilted downward in the rear and upward in the front, an articulator being drawn in schematically as an example, matches the image in FIG. 7e;

FIG. 4 is an advantageous embodiment of the apparatus according to the invention for the assembly of jaw models in the articulator (here referred to as an assembly table) in side view, adjustments being made such that the transfer device is tilted upward in the rear and downward in the front, an articulator being drawn in schematically as an example, matches the image in FIG. 7e;

FIG. 5 is an advantageous embodiment of the apparatus according to the invention for assembly of the jaw models in the articulator (here referred to as an assembly table) seen from above, set in the starting position, with a parallel mount (8) according to claim 32, with a centering device (7) according to claim 31, an articulator (4) being draw in schematically as an example, matches the image in FIG. 7e;

FIG. 6 is a detailed top view of an advantageous embodiment of the apparatus according to the invention for the assembly of jaw models in the articulator (here referred to as an assembly table), here an advantageous design of the articulator centering unit;

FIG. 7a-f show a few advantageous designs of the apparatus according to the invention for the assembly of jaw models in the articulator (here referred to as an assembly table) shown schematically and only partially, the individual detailed views of the positioning device for the transfer device (the groups are, represented schematically inside parenthesis at the end of the respective paragraphs);

FIG. 7a is an advantageous design of the apparatus according to the invention for the assembly of jaw models in the articulator (here referred to as an assembly table) shown schematically with nine longitudinally adjustable supports (3-3-3);

FIG. 7b is an advantageous design of the apparatus according to the invention for the assembly of jaw models in the articulator (here referred to as an assembly table) shown schematically with six longitudinally adjustable supports (2-2-2);

FIG. 7c is an advantageous design of the apparatus according to the invention for the assembly of jaw models in the articulator (here referred to as an assembly table) shown schematically with six longitudinally adjustable supports (3-2-1);

FIG. 7d is an advantageous design of the apparatus according to the invention for the assembly of jaw models in the articulator (here referred to as an assembly table) shown schematically with four longitudinally adjustable supports (3-1) and a positioning unit that is linearly adjustable in the x-, y- and z-directions;

FIG. 7e is an advantageous design of the apparatus according to the invention for the assembly of jaw models in the articulator (here referred to as an assembly table) shown schematically with three positioning units that are linearly adjustable in the in x-, y- and z-directions;

FIG. 7f is an advantageous design of the apparatus according to the invention for the assembly of jaw models in the articulator (here referred to as an assembly table) shown schematically with positioning unit that is linearly adjustable in the x-, y- and z-directions combined with the ability to rotate about the x-, y-, and z-axes (angles alpha α, beta β, gamma γ);

FIG. 8 is a detailed drawing of a transfer devices, here a bite fork, with a gap in front;

FIG. 9 is an advantageous design of the facebow for the lower jaw with four spheres as optical auxiliary structures (1) and contrast-enhancing backgrounds (2) shown schematically in horizontal projection;

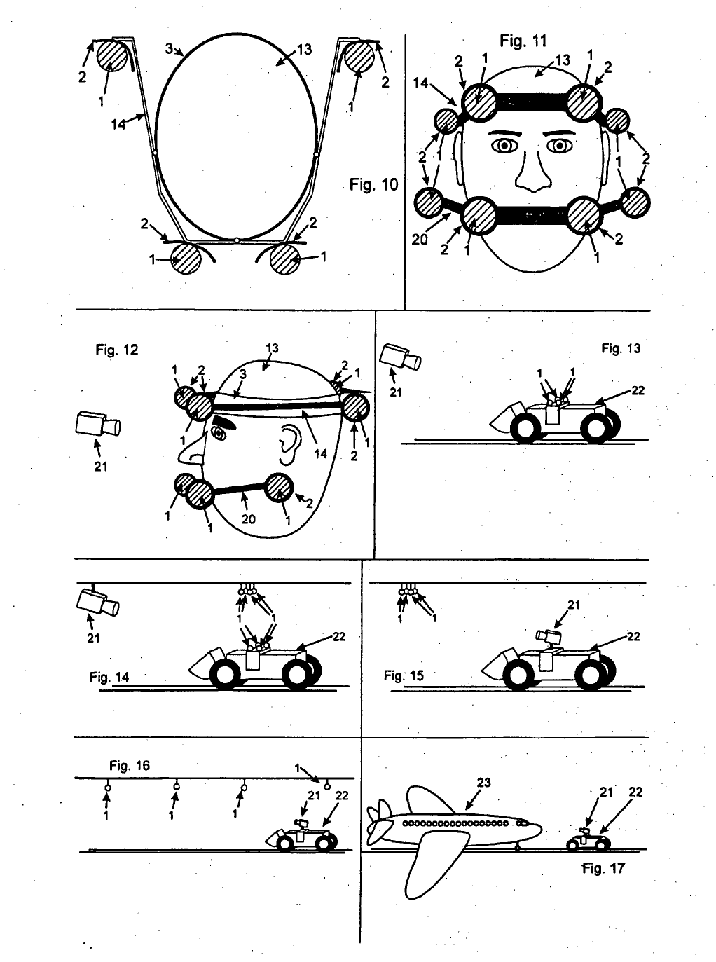

FIG. 10 is an advantageous design of the facebow for the assembly on the patient's head with four spheres as optical auxiliary structures (1), contrast-enhancing backgrounds (2), and an advantageous head mounting on the patient in the form of velcro® tape (3) shown schematically in horizontal projection;

FIG. 11 is an advantageous design of the facebow for the assembly on the patient's head and of the facebow for the lower jaw each with four spheres as optical auxiliary structures shown schematically, fastened on the patient, in front view;

FIG. 12 is an advantageous design of the facebow for the assembly on the patient's head and of the facebow for the lower jaw with four spheres each as optical auxiliary structures shown schematically, fastened on the patient, in side view.

The drawings images are not to scale and reflect one of many possible advantageous embodiments of the invention and are provided for better understanding only.

The present embodiment of the invention obtains through optical capture the data required for determining the condylar locations and movements, evaluates these data using the program according to the invention, and enables transfer of the results in the form of data to the dentistry laboratory. The jaw models are assembled in the articulator using an apparatus according to the invention for the assembly of jaw models in the articulator (here also referred to as an assembly table), which apparatus is adjusted by program to certain values.

According to FIGS. 10 through 12 and 13 transfer devices, e.g. in the form of a bite fork 11 with optical auxiliary structures 1 (e.g. spheres) according to the invention, are placed on the patient's head, e.g. on facebows 13 and 20, and optically captured by a camera 21, FIG. 9 showing a lower-jaw facebow 20, moving, as the jaw moves, against the upper-jaw facebow 14, which represents a reference system. It can be seen that the facebow 20 is connected via a coupling element 5 with the bite fork 11. Here too, contrast-enhancing backgrounds 2 are provided behind the auxiliary structures 1. A possible bite fork 19 according to the invention with a gap in front is shown in FIG. 8. This makes it possible that the final position of the teeth will cause no or only minor bite blockage by the bite fork 19, since the front teeth pass through the gap and the bite fork 19 only rests against the teeth in the molar area.

The images of the random or specified jaw movements are recorded in the form of individual images or video films. A program according to the invention computes the jaw positions and jaw movements according to the method described above and thereby determines the required data, e.g. condylar position.

The data for model assembly in the proper condylar axis position obtained in this way are not transferred mechanically to the laboratory, as is the case in all known systems, but only in the form of data. The only mechanical part required for the information transport, is a bite fork 11 or 19 with dental impressions or another simple transfer device. These transfer devices may be bite forks with an applied thermoplastic or auto-polymerizing material on top holding dental impressions of the upper or lower jaw, or both together, or jaw pattern in case of a strongly reduced set of teeth or the absence of teeth in the jaw, depending on the clinical patient situation.

This embodiment of the invention consists of the following parts according to the invention:

A camera, a computer program according to the invention, a forehead facebow (FIG. 10) with optical auxiliary structures, a lower-jaw fadebow (FIG. 9) with optical auxiliary structures, an apparatus according to the invention for the assembly of jaw models in the articulator (here referred to as an assembly table), a transfer device: bite fork, spoon, patterns and other devices for transfer of the upper-jaw position or lower-jaw position onto the facebow and for fastening the facebow on the lower jaw.

In order to capture the jaw movements, the utilized transfer devices, especially individually made patterns or spoons in case of a reduced set of teeth or absence of teeth in the jaw, may be fixed with a support pin between the upper and lower jaw. The support pin is fastened on the upper jaw by using suitable devices (patterns or the transfer device applied for the upper jaw). The support pin rests against a plate placed in the lower jaw. When performing the movements, the patient always bites on the support pin. Due to a stable three-point support, the lower-jaw transfer device remains in its position. The three support points consist of both mandibular joints and the application of the support pins on the plate placed in the lower jaw. The point of the support pin is preferably spherical. The support pin may also be fastened with the lower jaw, so that the plate for supporting the point of the support pin is mounted in the upper jaw.

In a further embodiment of the invention, there is no longer any need for a registration, since the jaw is optically captured, and based on these data, the jaw models are assembled in the articulator according to the specific values.

By using these optical jaw measurements as a further embodiment of the invention, it is possible to fully omit mechanical transfers. Thus, with this method, sending a mechanical registration to the dentistry laboratory is no longer needed. With this method, the jaw models are assembled on the articulator in a device for the assembly of jaw models in an articulator according to geometrical data of certain reference points, e.g. cusps of individual teeth. The pertinent data are computed by a program according to the invention

Articulator and transfer device are fastened in the dentistry laboratory on a device for the assembly of jaw models in an articulator (assembly table) according to the invention. The assembly table 10, shown in FIGS. 1, 3, 4 and 5, is adjusted based on three-dimensional data determined by the program according to the invention. This may be done automatically, if required, provided the assembly table has automatic, e.g. electrically controlled actuators, whose position may be adjusted according to the computed values.

To position the transfer device 11 or 19, it is possible, e.g. to shift the relevant supports 16 meeting at their respective upper ends in one support point, which then become adjustable in three dimensions (x-, y- and z-directions), thereby allowing rotation about all axes in space (about the x-, y- and z-axes, angles alpha α, beta β, gamma γ) according to the embodiment, and possible also rotation about all axes in space, as shown in FIG. 7f.

FIGS. 7a to 7f show how supports 16 are provided on a base plate 17 or sliding panels 12 are provided in order to align the assembly carrier 9 according to FIG. 2, on which carrier a bite fork 11 or 19 is placed via a coupling 5 according to computed values. Thus, a jaw model fixed in the bite fork 11 may be adjusted relative to an articulator 4, FIGS. 1, 2, 3, 4 and 5 showing how carrier 9 is adjusted into the articulator device After adjustment, the jaw model associated with these adjustments may be assembled in the articulator. This procedure may need repeating for a specific patient depending on the situation.

As a rule, the following methods are of relevance: Assembly of the upper or lower jaws based on a transfer device 11 or 19 (pattern or bite fork), and subsequent assembly of the opposing jaw based on a registration or a further transfer device readjusted and refastened on the assembly table (pattern or bite fork), or assembly of the upper and lower jaws based on only one transfer device (pattern or bite fork).

Parts of this invention may also be used in connection with already known methods and apparatuses. For instance, data from other position measuring systems to be used in the program according to the invention may be (re)processed.

It is also possible to perform the joint-related jaw position determination with traditional facebow registrations and model assembly in the usual way in the articulator, while doing condylar path recording with an apparatus and method according to the invention. By recording the condylar paths in accordance with the invention, individual adjustment of the articulator becomes possible, i.e. also when performing the facebow registration and the jaw model assembly in a known way. Possible advantageous embodiments of the invention enabling this procedure include attachments that are fastened on a known facebow, contain optical auxiliary structures, or the use of a facebow fastened in an identical way at the same anatomical reference points on the patient as the known facebow, when optically recording movements.

This will ensure that an identical reference system is used, when optically recording movements, as is used during mechanical registration. The software on a data medium according to the invention is therefore able to compute articulator settings that are appropriate for the mechanically recorded situation.

FIGS. 1 and 3 through 5, furthermore, show additional parallel mounts 8 and a centering device 7 according to FIG. 6, enabling simpler adjustment of the articulator.

FIGS. 13 to 16 show a further application for positioning vehicles, e.g. underground excavators.

According to FIG. 13, a vehicle 22 may carry optical auxiliary structures 1 in order to be captured by camera 21, that may be provided, e.g. on a tunnel ceiling, and serve as reference positions, that is the position of the vehicle being monitored.

Alternatively, FIG. 14 shows that by using a camera 21, both optical auxiliary structures 1 on the vehicle, as well as optical auxiliary structures 1 on the tunnel ceiling having a known reference position may be captured. This, in turn, allows the position of the vehicle 22 to be determined.

FIG. 15 shows an embodiment in which the camera is carried by a vehicle 22. The position relative to the auxiliary structures 1 at the tunnel ceiling may thus be determined.

FIG. 16 likewise shows a camera on a vehicle 22, a single auxiliary structures 1 being fixed along the tunnel ceiling always at certain spacings, including at random positions, e.g. only one indicia at the tunnel ceiling or wall. The position of the indicia need then not be known, e.g. when the indicia are always placed in the middle of the tunnel. The system then knows that the position is always centered. Or, placement on the side would also be possible, since the system then also knows that the position is always centered. The vehicle may then travel from one indicia to the next, it being useful for at least one indicia always to be within the camera's field of view. However, the technical process of position determination according to the following claims remain the same. With greater positioning accuracy, it is then possible to work with several indicia with a known three-dimensional relation to one another.

FIG. 17 shows an application for a vehicle 22, towing an airplane 23, the towing vehicle latching on to the nosewheel of the airplane. In order to approach the nosewheel in the right position, the nosewheel is captured by a camera 21 on the vehicle whose nosewheel itself represents an optical auxiliary structure or which, in addition, may carry at least one auxiliary structure. Thus the vehicle may determine its exact position relative to the nosewheel and approach the nosewheel. Another towing-vehicle application is measuring the angle between the airplane and towing vehicle during operation in order to avoid, e.g. unfavorable angles, or to obtain necessary angle information, when navigating the towing vehicle.

### LIST OF REFERENCE NUMBERS

optical auxiliary structures 1
Contrast-enhancing backgrounds 2
Velcro® band 3
Articulator, 4
Coupling element 5
Vertical adjustment of the articulator stand surface (see claim 31) 6
Centering device (see claim 31) 7
Parallel mount (see claim 32) 8
Assembly triangle 9
Model assembly device (assembly table) 10
Bite fork or other transfer device 11
X-Y-z sliding table upon which joints are placed 12
Patient's head 13
Face bow: Reference bow for upper jaw/head 14
Articulator stand surface 15
Longitudinally adjustable supports, linear actuators 16
Assembly table, detail (here, e.g. base plate) 17
Positioning device, comprising a linear positioning unit adjustable in x-, y- and z-direction and enabling adjustment of a rotation unit and allowing rotation about three axes in space 18
Bite fork with front gap 19
Lower jaw facebow 20
Camera 21
Vehicle, e.g. stripping excavator or airplane tractor 22
Airplane 23

1. A method for position determination of at least one object, characterized in that images of at least one object may be captured by means of a single electronic camera, at least one optical auxiliary structure being fixed on the object to be measured, or on other structures with a fixed three-dimensional relation to the object to be measured, and dimensions/positions of at least one object relative to at least one reference position that is known or simultaneously captured by a camera may be determined by evaluating the positions of at least one auxiliary structure in the captured images by means of a computer program.

2. A method for position determination of at least one object, characterized in that images of the vicinity of the object are captured by means of a single electronic camera mounted on the object, at least one optical auxiliary structure being fixed in the vicinity, and dimensions/positions of at least one object relative to at least one known reference position, especially a reference position captured simultaneously by the camera, especially of at least one auxiliary structure are determined by evaluating the positions of at least one auxiliary structure in the captured images by means of a computer program.

3. The method according to claims 1 or 2, characterized in that an optical auxiliary structure is formed by
a. a surface of a certain color, and/or
b. a reflective surface, and/or
c. a colored body, and/or
d. a reflective body, especially a spherical body, especially the relative positions of the optical auxiliary structures to one another and/or the object to be measured being known, when forming auxiliary structures by means of several of the above-mentioned elements.

4. The method according to claim 3, characterized in that a reference position is created by at least one optical auxiliary structure, or the camera.

5. The method according to claim 3, characterized in that an optical auxiliary structure is provided with a contrast-enhancing background, whereby especially the background has a contrast to the color of the optical auxiliary structure.

6. Method according to claim 3, characterized in that the elements, especially spheres, of an optical auxiliary structure are fixed in one plane, whereby especially the arrangement of the elements in this plane is trapezoid, whereby especially the elements mounted behind as seen from the direction of the camera are at a greater spacing relative to one another than do those mounted in the front.

7. The method according to claim 3, characterized in that an optical auxiliary structure is formed by at least one element of an object to be measured.

8. The method according to claim 3, characterized in that the position of an object relative to at least one reference position is determined based on a two-dimensional image containing at least one recorded auxiliary structure by using at least one of the following procedural steps:
a. Recognition of at least one auxiliary structure in a recorded image
b. Assignment of the auxiliary structure recognized in the image to real auxiliary structure.
c. Computation of a theoretical image of a at least one auxiliary structure.
d. Adaptation of the image parameters of a theoretical image to the recorded image, especially until maximum agreement among the images occurs.
e. Application of the adapted image parameters in order to determine the real position of the object relative to the reference position.

9. The method according to claim 8, characterized in that in order to recognize an auxiliary structure in a recorded image, the image is covered with a grid, whose width is less than or equal to the expected size of an auxiliary structure, pixel located in the grid being evaluated as to whether or not it belongs to an auxiliary structure.

10. The method according to claim 9, characterized in that with a positive evaluation of a pixel, the edge of the established auxiliary structure is determined.

11. The method according to claim 3, characterized in that an object to be measured is represented by a vehicle, especially whose movement is controlled by positions measured relative to at least one reference position.

12. The method according to claim 11, characterized in that a destination to be approached by a vehicle is marked by at least one optical auxiliary structure or at least one representation projected onto the destination.

13. The method according to claim 3, characterized in that an object to be measured is represented by the lower jaw of a person, at least one optical auxiliary structure being fixed on the lower jaw especially by means of at least one facebow.

14. The method according to claim 13, characterized in that a reference position is formed by the upper jaw, at least one optical auxiliary structure being fixed on the upper jaw or other head areas, especially by means of at least one facebow.

15. The method according to claim 13, characterized in that reference positions are formed by individual teeth, especially the cusps of individual teeth.

16. The method according to claim 13, characterized in that a person whose jaw positions, especially the condyles are to be measured, performs random jaw movements, while the movement is being captured by a camera.

17. The method according to claim 13, characterized in that the position of the lower jaw relative to the upper jaw, especially several positions, if the lower jaw moves relative to the upper jaw, is/are determined based on the recorded images, especially the position of the condylar axes being determined based on these relative positions.

18. The method according to claim 13, characterized in that a facebow with at least one optical auxiliary structure is connected with a jaw, especially a lower jaw, by means of a transfer device, especially a bite fork, paraocclusal bite fork, jaw pattern, whereby especially at least a second facebow is placed on the head.

19. The method according to claim 18, characterized in that a jaw position is transferred by means of transfer device onto a facebow or a device for assembling a jaw model in an articulator.

20. The method according to claim 13, characterized in that a jaw position is transferred onto a device for the assembly of jaw models in an articulator through optical capture of at least three distinct points of the jaw directly in the mouth or in a negative registration form, the position of these points being set in relation to at least one reference position, especially a facebow, in order to arrange the jaw models with the same distinct positions in the articulator relative to the reference position.

21. The method according to claim 13, characterized in that a device for the assembly of at least one jaw model in an articulator is used, the jaw models of the device being adjusted relative to the articulator based on dimensional data acquired from the images, especially angles or lengths, whereupon especially a jaw model is rigidly connected to the articulator.

22. The method according to claim 13, characterized in that a virtual jaw model is simulated by means of a computer system that especially is adjusted into a virtual articulator based on acquired dimensional data, especially in order to simulate a jaw movement and represent it virtually.

23. The method according to claim 13, characterized in that a masticating surface to be prepared of the tooth to be prepared is computed based on a virtual jaw model, especially after optical capture of the contours of the teeth and simulated comparison of a tooth to be prepared with an existing tooth of the opposing jaw, especially if a simulated movement of the jaw model occurs, which computation is done while especially taking into account the shaping of the masticating surface of the opposing tooth, whereby by means of the computed masticating surface data, especially automatic creation of a dental prosthesis or an inlay for the tooth to be prepared is made.

24. (canceled)

25. Software for implementing the method of claim 13 by means of a computer system running software, characterized in that the software computes at least the condylar positions, and especially the condylar paths and all data required for adjusting the articulators based on random, optically captured movements of the jaws relative to one another, especially of at least one auxiliary structure placed on the jaws, and especially the data required the adjustment of a device for assembling the jaw models in the articulator are computed, whereby instead of an optical data source, data from other sources, especially from ultrasound-based navigation, other optical navigation systems, and other navigation systems of any type also form the basis for further processing.

26. A transfer device, characterized in that at one end it comprises a coupling element allowing for precise repositionable assembly on a facebow with optical auxiliary structures, or on a device for the assembly of at least one jaw model in an articulator on a corresponding counterpart.

27. The transfer device according to claim 26, characterized in that it comprises a bite fork that is adaptable on teeth, while applying malleable registration materials, especially wax, auto-polymerizing plastics, casting compounds, silicone or thermoplastic materials, and the teeth in these registration materials leave impressions that enable precise repositionability of the jaw models.

28. The transfer device according to claims 26, characterized in that a bite fork in the front teeth area has a gap, whereby in certain bite situations especially involving a frontal deep bite with strongly overlapping teeth in the occlusion, only minor bite blockage or none at all occurs, when making the registration, due to the bite fork.

29. A device for assembling at least one jaw model in an articulator characterized in that for the assembly of a jaw model in an articulator, the position of a jaw model relative to an articulator is established by adjusting the device based on default data obtained by the method of claim 3.

30. The device according to claim 29, characterized in that it has at least one coupling element for a transfer device or other registration device, whereby a jaw model may be mounted through three-dimensional adjustment of the position of the coupling element on an articulator based on the determined data.

31. The device according to claim 30, characterized in that vertical adjustment of the surface of the articulator stand is provided, so that the condylar axis of the articulator may be flanged exactly onto a condylar receptacle of the device, and/or a centering device is provided, whereby any articulator regardless of its structural dimensions may be adjusted centrally in the device.

32. The device according to claim 29, characterized in that a parallel mount is provided, which device is placed especially laterally on a base surface and having a support with a moveable extension arm, upon which an upper part of the articulator may be supported during model assembly, whereby the extension arm has a height ensuring that the upper part of the articulator is mounted substantially parallel to the base area.

33. The device according to claim 29, characterized in that a positioning device for aligning a coupling element for a transfer device having three adjustable support points is provided, the coupling element being provided especially at a skeletonized carrier element, which may be mounted in the support points.

34. The device according to claim 33, characterized in that a positioning device comprises nine longitudinally adjustable supports split in three groups, each consisting especially of three supports, supports of each group meeting in one point above a base area, and this common point forms one of three support points.

35. The device according to claim 33 characterized in that the positioning device has six longitudinally adjustable supports, split in three groups, each consisting of two supports, and two supports of a group of two meet in one point above a base area, and this common point forms one of three support points.

36. The device according to claim 33 characterized in that the positioning device has six longitudinally adjustable supports, split in three groups, one group comprising three supports, one group two supports, and one group only one support, and in each case, the supports of one group meet at one point above the assembly table base area, and this common point forms one of three supporting points.

37. The device according to claim 33 characterized in that a positioning device comprises four longitudinally adjustable supports, split in two groups, one group comprising three supports, and one group only one support, and in each case, the supports of one group meet in one point above the assembly table base area, and this common point forms one of three support points, the third support point being formed by a point stored on a positioning unit that is linearly adjustable in the x-, y- and z-direction.

38. The device according to claim 33 characterized in that a positioning device comprises four longitudinally adjustable supports, and a linear positioning unit that is adjustable in the x-, y- and z-direction, whereby the four longitudinally adjustable supports are split in two groups of two.

39. The device according to claim 34 characterized in that supports of one group are moveably fastened at intervals on the assembly table base area, or at the assembly table, especially with a type of spherical joint or other joints, resulting in a geometrical distribution that enables precise geometric computation of the position of the support elements on the support points.

40. The device according to claim 33 characterized in that a positioning device comprises three positioning units that are linearly adjustable in the x-, y- and z-directions, including support points.

41. The device according to claim 33 characterized in that a positioning device comprises a positioning unit that is linearly adjustable in the x-, y- and z-directions, whereby this positioning unit enables adjustment of a rotation unit allowing for rotation about three axes in space, and upon which, a coupling element for the transfer device is attached, and the linear displacement measurements for the x-, y-, z-positioning unit and the angle of rotation about all axes in space, and thus the three-dimensional orientation of the coupling element, is/are adjustable.

42. An auxiliary device, especially a facebow, characterized in that it is attachable on a jaw by means of a transfer device, especially a bite fork, and carrying optical auxiliary structures, by means of which, the position of a lower jaw relative to a reference position, especially of an upper jaw, may be captured optically by means of a camera.

43. (canceled)
